(19) United States
(12) Patent Application Publication
(10) Pub. No.: US 2014/0062891 A1
(43) Pub. Date: Mar. 6, 2014

(54) STEERING WHEEL WITH ROTATABLE DISPLAY AND FIXED/MOVABLE IMAGES

(71) Applicant: Patrick Powell, Farmington Hills, MI (US)

(72) Inventor: Patrick Powell, Farmington Hills, MI (US)

(73) Assignee: DENSO INTERNATIONAL AMERICA, INC., Southfield, MI (US)

(21) Appl. No.: 13/596,428

(22) Filed: Aug. 28, 2012

(51) Int. Cl. G06F 3/041

(52) U.S. Cl. 345/173

(57) ABSTRACT

A control and display system for a steering wheel of a vehicle includes a touchscreen device, a first touch point, and a second touch point. The touchscreen device is mounted to the steering wheel and has a first surface and an opposing second surface. The first surface displays at least one vehicle control parameter. The first touch point is arranged on the first surface of the touchscreen device. The second touch point is arranged on the second surface of the touchscreen device. A phantom image of the second touch point is visible on the first surface of the touchscreen device.

### FIELD

The present disclosure relates generally to steering devices for automotive vehicles. More particularly, the present disclosure relates to a steering device having a rotatable display for viewing movable images in a fixed plane.

### BACKGROUND

This section provides background information related to the present disclosure which is not necessarily prior art.

Vehicles today commonly provide a wide variety of operating information through dashboard and instrument panel displays. For example, as shown in FIG. 6, a plurality of gauges 100 are arranged within an instrument panel or dashboard display 102 of a vehicle interior 104. The gauges 100 can be used to indicate information pertaining to the operating conditions of the vehicle, such as vehicle speed, engine coolant temperature, engine oil temperature, fuel level, oil pressure, battery voltage and the like. These gauges 100 are typically arranged for viewing within the driver's peripheral vision, and oftentimes, are visible through a steering wheel 106 of the vehicle. Similarly, switch assemblies 108 for controlling one or more accessory system (e.g., stereo controls 110, cruise control, mobile communication systems, navigation, heating/cooling, etc.) are typically arranged in convenient locations near a driver's seat. For example, stereo controls 110 may be arranged within arm's length on a center console 112 or integrated directly into the steering wheel 106.

Monitoring and/or controlling each of these functions, however, may be impaired by rotation of the steering wheel 106. For example, the steering wheel 106 typically includes a center hub 114 and plurality of spokes 116 that can block visibility of the gauges 100 during rotation of the steering wheel 106. Furthermore, the placement of these gauges 100 and switches 108 in the center console 112 requires a driver to move eyes and/or hands away from the steering wheel 106 during use, thereby disrupting the safe operation of the vehicle.

### SUMMARY

This section provides a general summary of the disclosure, and is not a comprehensive disclosure of its full scope or all of its features.

The present disclosure relates to a control and display system for a steering wheel of a vehicle, which includes a touchscreen device, a first touch point, and a second touch point. The touchscreen device is mounted to the steering wheel and has a first surface and an opposing second surface. The first surface displays at least one vehicle control parameter. The first touch point is arranged on the first surface of the touchscreen device. The second touch point is arranged on the second surface of the touchscreen device. A phantom image of the second touch point is visible on the first surface of the touchscreen device.

In another form, the present disclosure provides a control and display system for a steering wheel of a vehicle that includes a touchscreen device mounted to the steering wheel having a first surface and an opposing second surface. A first sensor is arranged on the first surface of the touchscreen device. A second sensor is arranged on the second surface of the touchscreen device. A control parameter is displayed on the first surface of the touchscreen device and is movable from a first position to a second position when the touchscreen device is rotated, so as to remain stationary with respect to the vehicle.

In still another form, the present disclosure provides a method that includes providing a touchscreen device mounted to a steering wheel. The touchscreen device has a first surface with a first sensor arranged thereon and an opposing second surface with a second sensor arranged thereon. A first position is selected to display a gauge having an operating parameter on the touchscreen device. The gauge having the operating parameter is then displayed in the first position on the touchscreen device when the steering wheel is in an initial position. The steering wheel is rotated a predetermined distance from the initial position and the gauge is rotated the predetermined distance in an opposite direction from the steering wheel rotation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle interior that incorporates a touchscreen device in a steering wheel in accordance with the present disclosure;

FIG. 2 is a cross-sectional view of the vehicle interior of FIG. 1;

FIG. 3 is a front perspective view of the steering wheel illustrated in FIG. 1 rotated to the left;

FIG. 4 is a front perspective view of the steering wheel illustrated in FIG. 1 rotated to the right;

FIG. 5 is a front perspective view of the steering wheel illustrated in FIG. 1 depicting a rear touch-sensitive area; and

FIG. 6 illustrates a prior art automotive vehicle interior.

Corresponding reference numerals indicate corresponding parts throughout the several views of the drawings.

### DETAILED DESCRIPTION

Example embodiments will now be described more fully with reference to the accompanying drawings.

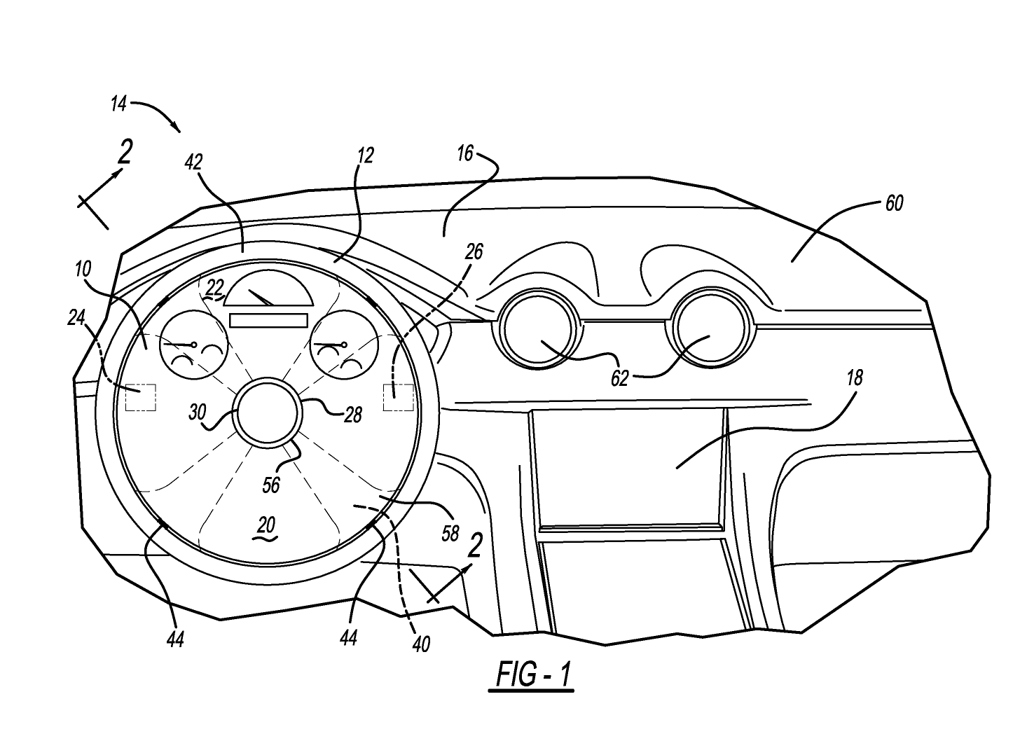

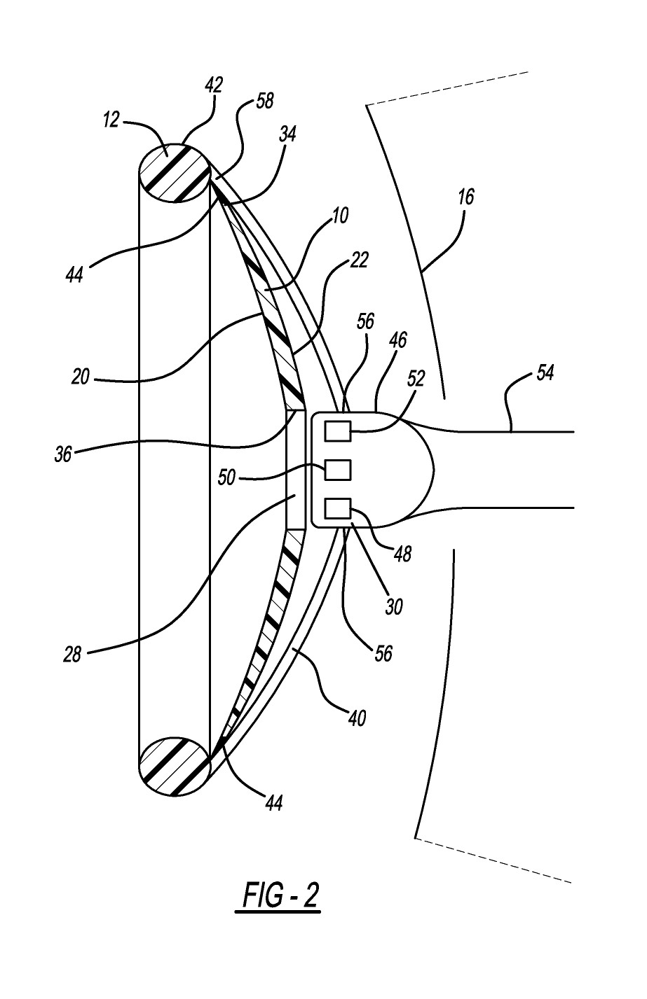

The following description is merely exemplary in nature and is not intended to limit the present disclosure, application, or uses. Referring now to the drawings in which like reference numerals designate like components throughout the several views, there is shown a touchscreen device in accordance with the present disclosure, and which is designated by the reference numeral 10. The preferred embodiment of the touchscreen device 10, as shown in FIGS. 1 and 2, may be mounted to a steering wheel 12 of a vehicle interior 14. The vehicle interior 14 may include the touchscreen device 10 mounted in the steering wheel 12, and may also include a dashboard 16 arranged about the steering wheel 12 and a center console 18 arranged adjacent the dashboard 16.

The touchscreen device 10 may have a first surface 20, a second opposing surface 22, a touch sensor or touch point 24 arranged on the first surface 20, a touch sensor or touch point 26 arranged on the second surface 22, and a center aperture 28 sized for receiving a hub 30 of the steering wheel 12. The touchscreen device 10 may utilize any type of touchscreen technology, such as bending wave, infrared (grid), optical, projected capacitive, resistive, surface acoustic wave (SAW), or surface capacitive. Furthermore, the touchscreen device 10 may utilize any type of display technology, such as thin film transistor (TFT), LED-backlit, organic light-emitting diode (OLED), or Blue Phase. Preferably, however, the touchscreen device 10 is a capacitive, TFT display.

The first surface 20 of the touchscreen device 10 may be arranged to face outwardly toward the vehicle interior 14 so as to be visible to a vehicle operator 32 (FIG. 3), while the second opposing surface 22 may be arranged to face toward the dashboard 16. The touchscreen device 10 may be flat or may have a generally concave shape such that an outer edge 34 adjacent the steering wheel 12 is closer to the vehicle operator 32 than an inner edge 36 defining the center aperture 28. Although not shown, the touchscreen device 10 may also be mounted so as to telescope and/or pivot about the center point. The touchscreen device 10 may be mounted to a center pivot (not shown) arranged about the hub 30 of the steering wheel 12. The center pivot may be an electrically sensitive, loaded spring so that the vehicle operator 32 may use movement of the touchscreen device 10 to operate certain vehicle functions. For example, the vehicle operator 32 may “tilt” the touchscreen device 10 to the right to activate the right blinker.

Furthermore, the touch points 24, 26 may include any touch interface known in the art, such as, a multi-touch screen capable of simultaneously detecting and resolving two or more points of contact. In this way, the touch points may be movable to various positions on the first surface 20, while still providing operative characteristics. For example, the vehicle operator 32 may move hand position from a 9 o'clock (left) and 3 o'clock (right) to a 5 o'clock (left) and 10 o'clock (right) position during a turning maneuver. The touch points 24, 26 may follow this hand movement allowing the vehicle operator 32 to keep hands fixed on the steering wheel 12 at all positions while still operatively using the touch points 24, 26.

The steering wheel 12 may include the hub 30, a plurality of spokes 40, a circumferential rim 42, and a plurality of attachment members 44. The hub 30 may include a housing 46, an air bag module 48, a horn module 50, and a control module 52. The housing 46 may be a tapered component sized for receiving the air bag module 48, horn module 50, and control module 52. The housing 46 may be indirectly in communication with the vehicle wheels (e.g., through a steering shaft 54) for affecting the vehicle movement when the operator 32 rotates the rim 42 of the steering wheel 12. The control module 52 may be secured within the housing 46 and may be in communication with various sensors and communication modules throughout the vehicle. The control module 52 may also be in communication with the touchscreen device 10 for providing various menus and gauges for vehicle operator 32 usages, as will be described in more detail below.

The housing 46 may be fixedly joined with a first end 56 of the spokes 40, so as to space the spokes 40 about the housing 46. Similarly, a second end 58 of the spokes 40 may be secured to the rim 42 so as to fixedly join the rim 42 to the hub 30. Furthermore, the spokes 40 may have a convex shape so as to raise the rim 42 above a plane of the hub 30. While the steering wheel 12 is shown as having four (4) spokes 40, it should be understood that any number of spokes 40 could be used. For example, it is contemplated that a single spoke in the form of a bowl may extend between the hub 30 and the rim 42.

The rim 42 may also be of any shape, but is preferably a substantially toroidal member sized for accepting hands of the vehicle operator 32. In this way, the operator 32 may grip and rotate the rim 42 of the steering wheel 12 to affect rotational movement of the hub 30 during various vehicle maneuvers. The rim 42 may also include the plurality of attachment members 44 extending inwardly toward the hub 30. The attachment members 44 may be any type of fastener known in the art for securing the touchscreen device 10 to the steering wheel 12, such as screws or clips. In this way, the touchscreen device 10 may be removably mounted to the steering wheel 12 for ease in cleaning and repair. The attachment members 44 may also provide a frangible connection to the steering wheel 12, so as to allow the touchscreen device 10 to break away from the steering wheel 12 in a collision event. It should also be understood that while the attachment members 44 are described as being secured to the rim 42, it is also contemplated that the attachment members 44 could be arranged along the spokes 40 or the hub 30. Notably, the touchscreen device 10 may also be axially movable relative to the steering wheel 12 in order to be adjustable for comfort of the vehicle operator 32.

The dashboard 16 and center console 18 may include fascia 60 and a plurality of vent openings 62. Notably, however, the dashboard 16 and center console 18 do not include any gauges or switches as found in prior art arrangements. In this way, the dashboard 16 and/or center console 18 may include additional space for storage compartments or other decorative or functional items. The elimination of the gauges and switches, however, provides reduced eye and hand movement from the direction of the steering wheel 12 to the directions of the dashboard 16/center console 18.

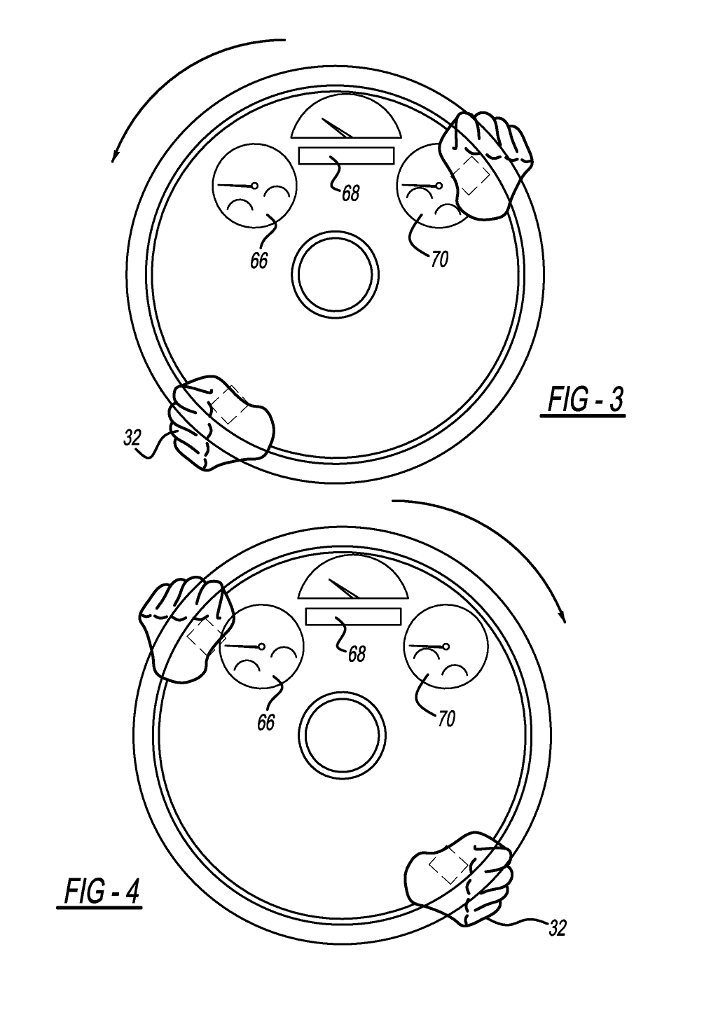

The touchscreen device 10 may be operable for displaying selected vehicle control or operating parameters, as show in FIGS. 3 and 4. The vehicle operator 32 may provide an input to the touchscreen device 10 (e.g., through an on-screen menu selection) indicating a selected display option. For example, the vehicle operator 32 may select a position to display a selected gauge or gauges 66, 68, 70 on the touchscreen device 10. The selected gauges 66, 68, 70 can provide selected vehicle operating parameters (e.g., vehicle speed, engine coolant temperature, engine oil temperature, fuel level, oil pressure, battery voltage, etc.). The selected gauges 66, 68, 70 may be operator selectable and relocatable. For example, the vehicle operator 32 may choose to display radio, temperature, and speed control gauges. These gauges may be placed anywhere on the touchscreen device 10.

In one example, the selected gauges 66, 68, 70 may be displayed at a first position on the touchscreen device 10 (e.g., center top) corresponding to an initial position of the steering wheel 12 (e.g., vehicle wheels straight). During a vehicle maneuver, such as turning a corner, the steering wheel 12 may be rotated a predetermined distance from the initial position (e.g., 45 degrees to the left as shown in FIG. 3 or to the right as shown in FIG. 4). The selected gauges 66, 68, 70 on the touchscreen device 10 may rotate to a second position approximately equal in magnitude and directionally opposite to the rotational difference between the initial position and the rotated position of the steering wheel 12 (e.g., positive 45 degrees as shown in FIG. 3 or negative 45 degrees as shown in FIG. 4). In other words, the selected gauges 66, 68, 70 may rotate in a counter-angle to the steering wheel 12 rotation so as to remain stationary with respect to the vehicle. For example, if the vehicle operator 32 rotates the steering wheel 12 left (e.g., to steer the vehicle left) the selected gauges 66, 68, 70 rotate right giving the vehicle operator 32 the ‘appearance’ that the selected gauges 66, 68, 70 have not moved relative to their view plane. It is also envisioned, however, that the selected gauges 66, 68, 70 would rotate out of the forward view field of the vehicle operator 32 (e.g., image would move left or right of the view field). This proposed option may be necessary due to hand position of the vehicle operator 32.

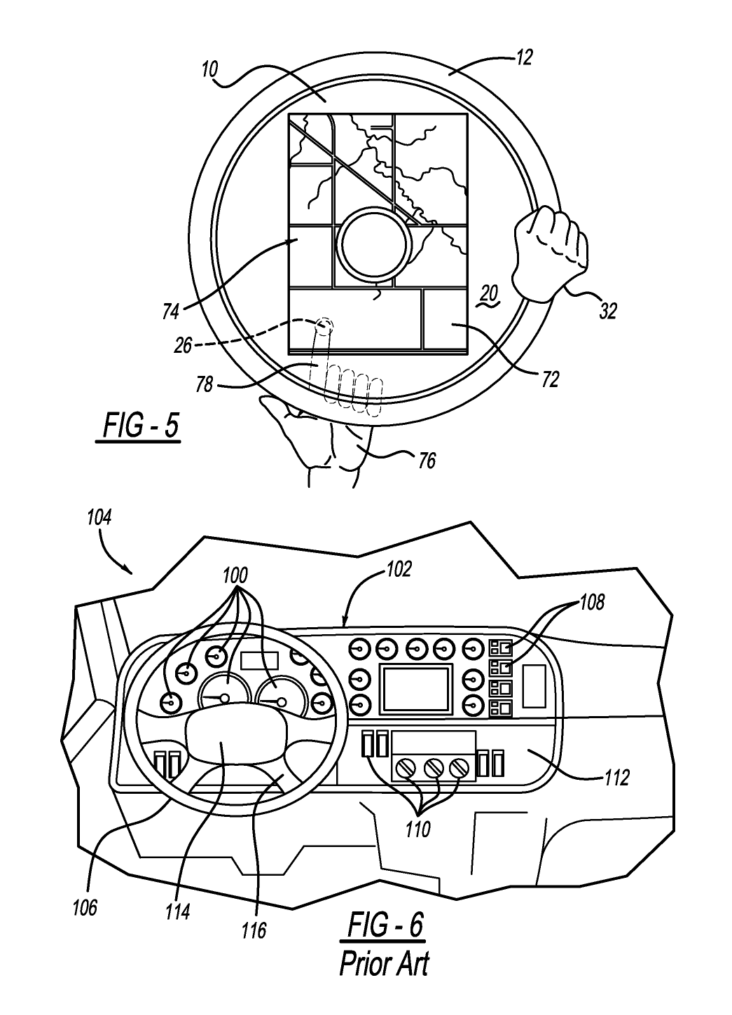

In another example, the vehicle operator 32 may select display of a navigation screen 72 on the touchscreen device 10 as shown in FIG. 5. The navigation screen 72 may include a map 74 for display on the touchscreen device 10. While driving, it may be beneficial to allow the vehicle operator 32 to select portions of the navigation screen 72 without covering those portions with a hand 76. Accordingly, the vehicle operator 32 may use the rear touch point 26 so as to select the appropriate portion without covering the map 74 with the hand 76. The proposed design could also provide a phantom image 78 of the rear touch point 26 or the hand 76 behind the steering wheel 12, for example, through the use of a video or other sensing system (not shown) built into or mounted on the steering wheel 12. In this way, the phantom image 78 of the touch point 26 can be visible on the first surface 20 of the touchscreen device 10 for allowing the vehicle operator 32 to visibly move their fingers for activating various display points on the first surface 20.

While the touchscreen device 10 is shown and described as displaying gauges 66, 68, 70 and a navigation screen 72, it should also be understood that the touchscreen device 10 is capable of displaying other visual images and data. For example, the vehicle operator 32 may “upload” personal images (e.g., photographs, logos, slogans, etc.) to the vehicle (e.g., through a USB interface, which is not shown) and select them to display as an image on the touchscreen device 10. The images may also appear as a “background” behind selected gauges 66, 68, 70. Additionally, the vehicle operator 32 may select to display front/rear vehicle camera information on the touchscreen device 10. In this way, the touchscreen device 10 may provide video display for the camera information (e.g., backup video camera display on the touchscreen device 10 for reverse driving).

It is also contemplated that the vehicle operator 32 may pilot the vehicle with the touchscreen device 10. In one example, the vehicle operator 32 may use up and down motions of the hand 76 to turn the vehicle left or right. In another example, the vehicle operator 32 may use any number of fingers of the hand 76 swiped in a left-to-right or right-to-left motion to turn the vehicle left or right. In yet another example, when the vehicle is placed into autonomous operation, the touchscreen device 10 can be used as a personal computing device allowing the operator to search the internet, type memos or texts, etc. as the vehicle drives itself. In this way, the touchscreen device 10 can have a keyboard interface, a text box, search functions, a video display, etc. It is contemplated that the autonomous function may allow the steering wheel 12 to lock, thereby preventing rotation of the touchscreen device 10 for improved functionality. In this example, however, the air bag module 48 may be relocated from the hub 30 to another part of the vehicle allowing for a full, non-interrupted screen.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A control and display system for a steering wheel of a vehicle comprising:
a touchscreen device mounted to the steering wheel, the touchscreen device having a first surface and an opposing second surface, the first surface displaying at least one vehicle control parameter;
a first touch point arranged on the first surface of the touchscreen device; and
a second touch point arranged on the second surface of the touchscreen device, wherein a phantom image of the second touch point is visible on the first surface of the touchscreen device.

2. The control and display system of claim 1, wherein the first and second touch points are multi-touch sensors.

3. The control and display system of claim 1, wherein the touchscreen device is a thin film transistor liquid crystal display.

4. The control and display system of claim 1, wherein the touchscreen device is concave.

5. The control and display system of claim 1, wherein the touchscreen device is a personal computing device when the vehicle is driven autonomously.

6. The control and display system of claim 1, wherein the touchscreen device includes a central opening.

7. The control and display system of claim 1, wherein the touchscreen device is mounted to the steering wheel with a plurality of frangible members.

8. The control and display system of claim 1, wherein the touchscreen device is removably mounted to the steering wheel with a plurality of fasteners.

9. The control and display system of claim 1, wherein the at least one control parameter is provided in a first location when the steering wheel is in an initial position and a second location when the steering wheel is in a rotated position, wherein the rotational difference between the first location and the second location is approximately equal in magnitude and directionally opposite to the rotational difference between the initial position and the rotated position.

10. The control and display system of claim 9, wherein first location is operator selectable.

11. A control and display system for a steering wheel of a vehicle comprising:
a touchscreen device mounted to the steering wheel having a first surface and an opposing second surface;
a first sensor arranged on the first surface of the touchscreen device;
a second sensor arranged on the second surface of the touchscreen device; and
an operating parameter displayed on the first surface of the touchscreen device, wherein the operating parameter is movable from a first position to a second position when the touchscreen device is rotated so as to remain fixed in a plane with respect to the vehicle.

11. The control and display system of claim 11, wherein the first and second sensors are multi-touch sensors.

13. The control and display system of claim 11, wherein a phantom image of the second sensor is visible on the first surface of the touchscreen device.

14. The control and display system of claim 11, wherein the touchscreen device is a thin film transistor liquid crystal display.

15. The control and display system of claim 11, wherein the touchscreen device is concave.

16. The control and display system of claim 11, wherein the touchscreen device includes a central opening.

17. The control and display system of claim 11, wherein the touchscreen device is mounted to the steering wheel with a plurality of frangible members.

18. The control and display system of claim 11, wherein the touchscreen device is removably mounted to the steering wheel with a plurality of fasteners.

19. The control and display system of claim 11, wherein the first position of the operating parameter corresponds to an initial position for the steering wheel and the second position of the operating parameter corresponds to a rotated position for the steering wheel, wherein the rotational difference between the first position and the second position is approximately equal in magnitude and directionally opposite to the rotational difference between the initial position and the rotated position.

20. The control and display system of claim 19, wherein first position is operator selectable.

21. A method comprising:
providing a touchscreen device mounted to a steering wheel, the touchscreen device having a first surface with a first multi-touch sensor arranged thereon and an opposing second surface with a second multi-touch sensor arranged thereon;
selecting a first position to display a gauge having an operating parameter on the touchscreen device;
displaying the gauge having the operating parameter in the first position on the touchscreen device when the steering wheel is in an initial position;
rotating the steering wheel a predetermined distance from the initial position; and
rotating the gauge the predetermined distance in an opposite direction from the steering wheel rotation.

22. The method of claim 21, further comprising:
viewing the second sensor in phantom on the first surface of the touchscreen device.

23. The method of claim 21, further comprising:
removing the touchscreen device from the steering wheel.
